(19) United States
(12) Patent Application Publication
(10) Pub. No.: US 2011/0185276 A1
(43) Pub. Date: Jul. 28, 2011

(54) TEXT OUTPUT METHOD AND APPARATUS

(75) Inventor: Jong-kyu KIM, Seoul (KR)

(73) Assignee: SAMSUNG ELECTRONICS CO., LTD., Suwon-si (KR)

(21) Appl. No.: 13/012,192

(22) Filed: Jan. 24, 2011

(30) Foreign Application Priority Data
Jan. 28, 2010 (KR) 10-2010-0008047

(51) Int. Cl. G06F 17/21

(52) U.S. Cl. 715/244

(57) ABSTRACT

A text output method and apparatus are provided. The text output method includes outputting characters in horizontal lines on a screen, and the outputting the characters includes outputting the characters by performing line breaking in a lower-to-upper direction.

### CROSS-REFERENCE TO RELATED PATENT APPLICATION

This application claims priority from Korean Patent Application No. 10-2010-0008047, filed on Jan. 28, 2010, in the Korean Intellectual Property Office, the disclosure of which is incorporated herein in its entirety by reference.

### BACKGROUND

1. Field

Apparatuses and methods consistent with exemplary embodiments relate to a text output method and apparatus, and more particularly, to a text output method and apparatus for performing line breaking in a lower-to-upper direction when displaying text on a screen.

2. Description of the Related Art

A text output apparatus capable of displaying characters to users, such as a computer or a cellular phone, generally outputs characters in horizontal lines on a screen of the apparatus. When the number of characters to be included in a single horizontal line exceeds the number of characters of a line that can be output on the screen, or when a user inputs a line breaking command, such as an enter key, the text output apparatus outputs the characters after performing line breaking in a lower direction from a current line.

FIG. 1 shows a computer screen displayed to a user when a text output apparatus outputs characters by performing line breaking in an upper-to-lower direction. The computer screen shown in FIG. 1 is a micro-blogging screen where short sentences are frequently updated. In FIG. 1, comments, i.e., paragraphs 110 through 140, are written in predetermined time intervals and the temporally latest paragraph is displayed on the top of the screen. In FIG. 1, numbers “1” through “4” indicate the order in which the paragraphs are written, so that the paragraph 110 indicated by “1” on the bottom of the screen is the earliest written paragraph and the paragraph 140 indicated by “4” on the top of the screen is the latest written paragraph. In FIG. 1, arrows oriented in a lower-to-upper direction indicate the order in which the paragraphs are written, or the order in which a user reads the paragraphs when the user time-serially reads the paragraphs in the order the paragraphs are written.

Since a plurality of lines included in each paragraph have breaks in the upper-to-lower direction, the top line in a paragraph is the earliest written line and the bottom line in the paragraph is the latest written line. Therefore, the user reads the text of each paragraph in the upper-to-lower direction. In FIG. 1, arrows oriented in the upper-to-lower direction indicate the order in which text is written in an identical paragraph or the order in which the user reads lines in a paragraph when the user time-serially reads the lines.

When the user desires to time-serially read the paragraphs from the earliest written paragraph, the user has to first read the bottom paragraph on the screen and then sequentially read the paragraphs above the bottom paragraph. Within each paragraph, however, the user has to read text in the upper-to-lower direction. As a result, the user's eyes have to repeatedly move from bottom to top and then from top to bottom.

### SUMMARY

One or more exemplary embodiments provide a method and apparatus for performing line breaking in a lower-to-upper direction.

One or more exemplary embodiments provide also provides a method and apparatus which allows a user to select whether to perform line breaking in an upper-to-lower direction or in a lower-to-upper direction.

According to an aspect of an exemplary embodiment, there is provided a text output method including outputting characters in horizontal lines on a screen, in which the outputting the characters includes outputting the characters by performing line breaking in a lower-to-upper direction.

In an exemplary embodiment, the text output method may further include receiving a first command which commands line breaking in the lower-to-upper direction, in which the outputting the characters by performing line breaking in the lower-to-upper direction includes outputting the characters on the screen by performing line breaking in the lower-to-upper direction when the line breaking is performed after the receipt of the first command. The text output method may further include receiving a line breaking command, in which the outputting the characters by performing line breaking in the lower-to-upper direction is executed in response to the line breaking command.

The outputting the characters by performing line breaking in the lower-to-upper direction may include, if a number of characters to be output in a horizontal line exceeds a number of characters that can be output in a horizontal line on the screen, outputting the exceeding characters on the screen by performing line breaking in an upper direction with respect to a current line.

The text output method may further include, after outputting the characters by performing line breaking in the lower-to-upper direction, receiving a second command which commands line breaking in an upper-to-lower direction, and performing line breaking on the lower-to-upper direction line-broken characters output on the screen in the upper-to-lower direction and outputting the upper-to-lower direction line-broken characters when the line breaking is performed after receiving the second command.

The text output method may further include, before outputting the characters by performing line breaking in the lower-to-upper direction, receiving a second command for commanding line breaking in an upper-to-lower direction, and outputting the characters on the screen by performing line breaking in the upper-to-lower direction, in which the outputting the characters by performing line breaking in the lower-to-upper direction includes performing line breaking on the upper-to-lower direction line-broken characters output on the screen in the lower-to-upper direction and outputting the lower-to-upper direction line-broken characters.

According to another aspect of an exemplary embodiment, there is provided a text output method including outputting characters in horizontal lines on a screen, in which the outputting the characters includes, if a horizontal line including temporally later written characters is different from a horizontal line including temporally earlier written characters, outputting the characters on the screen by positioning the horizontal line including the temporally later written characters in an upper direction with respect to the horizontal line including the temporally earlier written characters.

According to another aspect of an exemplary embodiment, there is provided a text output apparatus including a screen which outputs characters in horizontal lines and a text processor which outputs the characters on the screen by performing line breaking in a lower-to-upper direction.

According to another aspect of an exemplary embodiment, there is provided a text output apparatus including a screen which outputs characters in horizontal lines and a text processor, if a horizontal line including temporally later written characters is different from a horizontal line including temporally earlier written characters, which outputs the characters on the screen by positioning the horizontal line including the temporally later written characters in an upper direction with respect to the horizontal line including the temporally earlier written characters.

According to another aspect of an exemplary embodiment, there is provided a computer-readable recording medium having recorded thereon a program for executing a text output method including outputting characters in horizontal lines on a screen, in which the outputting the characters includes outputting the characters by performing line breaking in a lower-to-upper direction.

According to another aspect of an exemplary embodiment, there is provided a computer-readable recording medium having recorded thereon a program for executing a text output method including outputting characters in horizontal lines on a screen, wherein the outputting the characters includes, if a horizontal line including temporally later written characters is different from a horizontal line including temporally earlier written characters, outputting the characters on the screen by positioning the horizontal line including the temporally later written characters in an upper direction with respect to the horizontal line including the temporally earlier written characters.

According to an exemplary embodiment, a method and apparatus allowing line breaking in a lower-to-upper direction during the output of text can be provided.

Moreover, a method and apparatus allowing a user to select a line breaking direction can be provided.

### BRIEF DESCRIPTION OF THE DRAWINGS

The above and other features and advantages will become more apparent by describing in detail exemplary embodiments thereof with reference to the attached drawings in which:

FIG. 1 shows a computer screen displayed to a user when a text output apparatus outputs characters by performing line breaking in an upper-to-lower direction according to the related art;

FIG. 2 is a block diagram of a text output apparatus according to an exemplary embodiment;

FIGS. 3 and 4 are views for explaining that text is output by performing line breaking in a lower-to-upper direction according to an exemplary embodiment; and

FIG. 5 is a flowchart illustrating a text output method according to an exemplary embodiment.

### DETAILED DESCRIPTION

Hereinafter, exemplary embodiments will be described in detail with reference to the accompanying drawings.

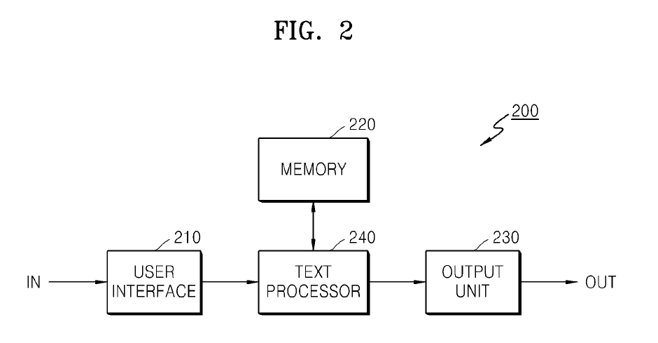

FIG. 2 is a block diagram of a text output apparatus 200 according to an exemplary embodiment. The text output apparatus 200 includes a user interface 210, a memory 220, an output unit 230, and a text processor 240.

The text output apparatus 200 according to the exemplary embodiment is an apparatus for outputting on a screen characters which constitute a visual symbol system for communication between humans, such as Korean characters, Chinese characters, English characters, or the like. Examples of the text output apparatus 200 may include a personal digital assistant (PDA), a portable multimedia player (PMP), a cellular phone, a digital TV, a navigation device, a notebook, such as a personal computer (PC) or an ultra mobile PC (UMPC), and so forth. Since text refers to data formed of characters output from a device, such as a computer, the terms ‘characters’ and ‘text’ will have the same meaning herein.

A command, a character, a number, or speech information is input to the user interface 210 by a user through a physical transducer, such as a keyboard, a keypad, a mouse, a touch pad, a touch screen, or a microphone, and provides the same to the text processor 240.

In the exemplary embodiment, the user interface 210 may receive a line breaking command for commanding a line break, such as an enter key. The user interface 210 may also receive from the user a line breaking direction command indicating a direction in which line breaking is performed. The line breaking direction command may be one of a first command for commanding line breaking in a lower-to-upper direction and a second command for commanding line breaking in an upper-to-lower direction. The user interface 210 provides the line breaking command and the line breaking direction command, which are input by the user to the text processor 240.

The memory 220 stores a program for driving the text output apparatus 200 and/or data which is input through the user interface 210 or an external server (not shown). The memory 220 may include a high-speed main memory of a storage medium type, such as a random access memory (RAM) or a read only memory (ROM), an auxiliary memory of a long-term storage medium type, such as a floppy disk, a hard disk, a tape, a compact disc-read only memory (CD-ROM), or a flash memory, and a device for storing data by using an electric storage medium, a magnetic storage medium, an optical storage medium, or other types of storage media. Although the memory 220 is shown as being included in the text output apparatus 200 in the exemplary embodiment, the memory 220 may be an external memory which is separate from the text output apparatus 200 and can be inserted in the text output apparatus 200 when necessary.

The output unit 230 outputs an overall state of the text output apparatus 200, a list for a user's selection through the user interface 210, or information which is input by the user through the user interface 210. In the exemplary embodiment, the output unit 230 may be a screen which displays characters. When receiving the line breaking command from the user while outputting characters in horizontal lines, the output unit 230 moves a cursor to an upper or lower line with respect to a line in which the cursor is positioned prior to the reception of the line breaking command. If the number of characters to be output in a horizontal line exceeds the number of characters that can be output in a horizontal line by the output unit 230, the output unit 230 may display the exceeding characters in an upper or lower line with respect to a current line even though the output unit 230 did not receive the line breaking command from the user.

The text processor 240 controls the overall operation of the text output apparatus 200 to perform a text output method according to an exemplary embodiment. In an exemplary embodiment, the text processor 240 may control a line breaking direction. That is, the text processor 240 may control text to be output on the output unit 230 by performing line breaking in the lower-to-upper direction or in the upper-to-lower direction.

The line breaking performed in the lower-to-upper direction by the text processor 240 means that when a horizontal line including characters that have to be read later in terms of time or in terms of the plot of text (‘a first horizontal line’ for short) is different from a horizontal line including characters that have to be read first in terms of time or in terms of the plot of the text (‘a second horizontal line’ for short), line breaking is performed to position the first horizontal line in an upper direction with respect to the second horizontal line.

When the user works on a document by using a word processing program such as a word processor, the text processor 240 outputs, in real time, on the output unit 230 characters which are input from the user through the user interface 210. Upon receipt of the line breaking command, such as the enter key, from the user, the text processor 240 moves a cursor to an upper or lower line with respect to a line where the cursor is positioned prior to the reception of the line breaking command, so that new characters input by the user are output from the cursor positioned in the new line.

When the user desires to use a document previously stored in the memory 220, the text processor 240 reads the desired document from the memory 220 and outputs characters included in the document on the output unit 230. The text processor 240 may output the characters by performing line breaking in the lower-to-upper direction or in the upper-to-lower direction.

Whether the text processor 240 performs line breaking in the lower-to-upper direction or in the upper-to-lower direction is determined by the line breaking direction command which is input from the user. That is, the line breaking direction used by the text processor 240 depends on whether the user interface 210 receives the first command or the second command from the user as the line breaking direction command.

If the user inputs the first command for commanding line breaking in the lower-to-upper direction through the user interface 210, the text processor 240 outputs text by performing line breaking in the lower-to-upper direction in response to the first command when the text processor 240 receives the line breaking command, such as the enter key, from the user, or the number of characters to be output exceeds the number of characters that can be output by the output unit 230.

Likewise, if the user inputs the second command for commanding line breaking in the upper-to-lower direction through the user interface 210, the text processor 240 outputs text by performing line breaking in the upper-to-lower direction when line breaking is required.

In the text processor 240, the line breaking direction may be set by default. That is, the text processor 240 may be set to automatically perform line breaking in the lower-to-upper direction or vice versa when the text output apparatus 200 outputs characters. If the text processor 240 is set by default to perform line breaking in the lower-to-upper direction, the text processor 240 outputs text by performing line breaking in the lower-to-upper direction unless a separate line breaking direction command is input by the user.

The text processor 240 may receive the second command from the user through the user interface 210 after text is output with line breaking in the lower-to-upper direction in response to the first command input from the user or by default. In this case, the text processor 240 may perform line breaking on the text, which is output on the output unit 230, in the upper-to-lower direction, and then output the line-broken text on the output unit 230. Similarly, if the text processor 240 receives the first command from the user through the user interface 210 after text is output with line breaking in the upper-to-lower direction in response to the second command input by the user or by default, the text processor 240 may perform line breaking on the text, which is output on the output unit 230, in the lower-to-upper direction, and then output the line-broken text on the output unit 230.

In this way, according to an exemplary embodiment, the text output apparatus 200 may perform line breaking in the lower-to-upper direction when outputting characters. According to an exemplary embodiment, whether to perform line breaking in the lower-to-upper direction or in the upper-to-lower direction may be selected by the user.

In an exemplary embodiment, the text processor 240 may be implemented by a hardware processor.

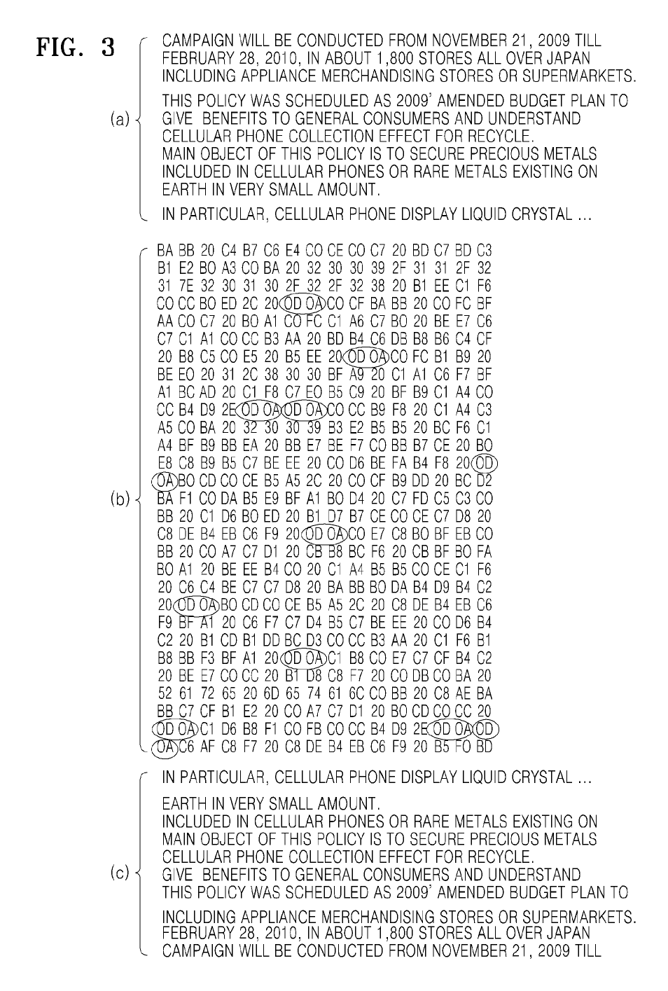

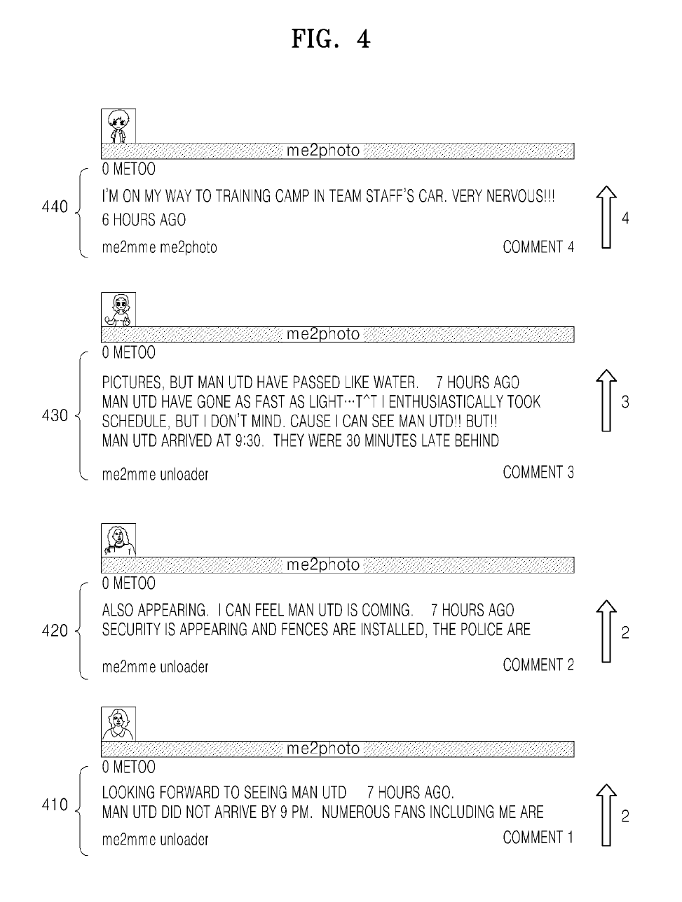

FIGS. 3 and 4 are views for explaining text that is output through line breaking in the lower-to-upper direction.

Text (a) of FIG. 3 shows text which is output through line breaking in the upper-to-lower direction. The user reads the text (a) in the upper-to-lower direction, from the first line positioned on the top to the last line in the third paragraph. To output the text (a) of FIG. 3, the text output apparatus 200 performs line breaking a total of eleven times. That is, the text output apparatus 200 performs line breaking twice to output three lines included in the first paragraph, five times to output six lines included in the second paragraph, twice between the first paragraph and the second paragraph, and twice between the second paragraph and the third paragraph.

Text (b) of FIG. 3 shows the text (a) of FIG. 3 in the format of hex codes which is recognized by a computer. In text (b) of FIG. 3, a code “OD OA” indicating a line break is shown a total of eleven times and is marked with a circle.

Once the text processor 240 is commanded to perform line breaking in the lower-to-upper direction by the user, the text processor 240 interprets the code “OD OA” in the codes in the text (b) of FIG. 3 according to an exemplary embodiment. The text processor 240 interprets this code as a code for commanding line breaking in the lower-to-upper direction rather than a code for commanding line breaking in the upper-to-lower direction, and outputs characters after performing line breaking in the lower-to-upper direction.

Text (c) of FIG. 3 shows text which is output by the text output apparatus 200 when line breaking is performed on the text (a) of FIG. 3 in the lower-to-upper direction. The text (c) of FIG. 3 is output through line breaking in the lower-to-upper direction, from the last line positioned on the bottom to the first line positioned on the top. Thus, the user reads the text (c) of FIG. 3 in the lower-to-upper direction.

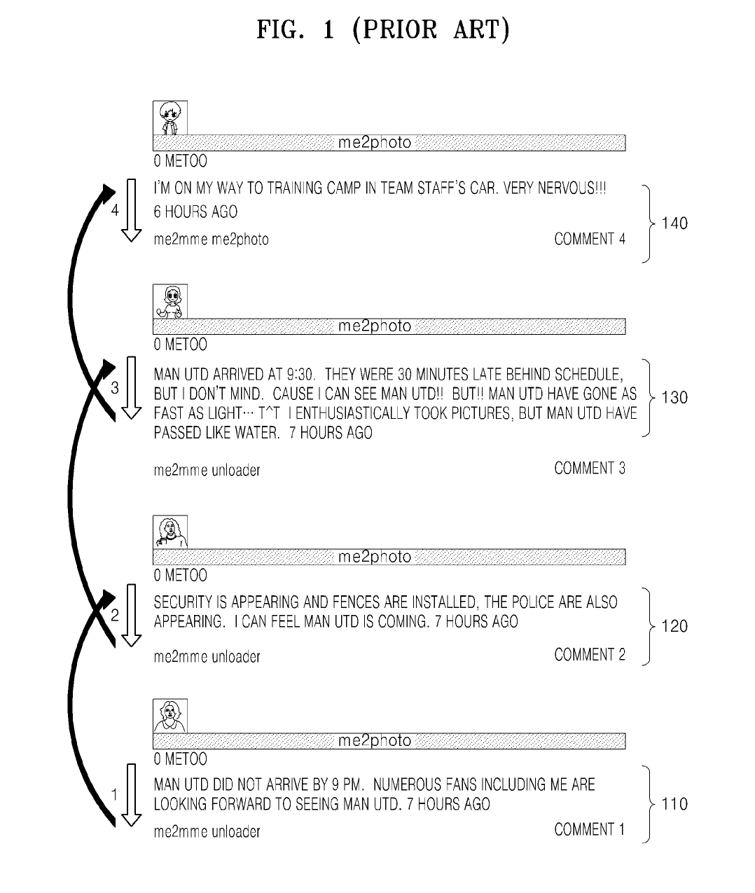

FIG. 4 shows a computer screen on which text is displayed with line breaking in the lower-to-upper direction when an exemplary embodiment is applied to the micro-blogging screen shown in FIG. 1.

The screen shown in FIG. 4 is a micro-blogging screen where short sentences are frequently updated. Paragraphs 410 through 440 are written time-serially. In FIG. 4, numbers “1” through “4” indicate the order in which the paragraphs are written, so that the paragraph 410 indicated by “1” is the earliest written paragraph and the paragraph 440 indicated by “4” is the latest written paragraph. In each paragraph, line breaking is performed in the lower-to-upper direction. Thus, in each paragraph, the bottom line is the earliest written line and the top line is the latest written line.

When the user desires to sequentially read paragraphs, which are output on a screen, from the earliest written paragraph, the user first reads paragraph 410 on the bottom of the screen and then sequentially reads paragraphs 420, 430, and 440 in this order. In FIG. 4, arrows oriented in the lower-to-upper direction indicate the order in which the paragraphs are written, or the order in which the user reads the paragraphs when the user time-serially reads the paragraphs in the order the paragraphs were written.

The user reads lines included in each paragraph in the lower-to-upper direction. Thus, the arrows shown in FIG. 4 indicate also the order in which lines in each paragraph are written, or directions in which the user reads the lines in each paragraph when the user time-serially reads the lines in each paragraph. That is, in FIG. 4, a direction the user reads paragraphs when the user time-serially reads the paragraphs and a direction the user reads lines in each paragraph are the same, i.e., the lower-to-upper direction. Accordingly, the user can consistently keep eyes in the lower-to-upper direction when reading text, thereby reducing movement of the user's eyes.

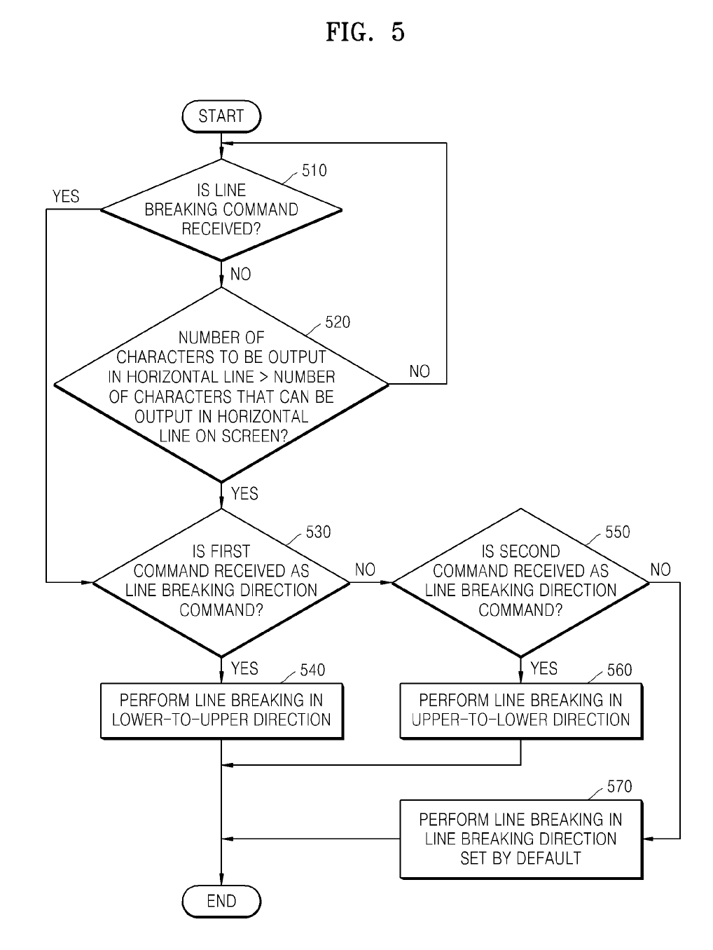

FIG. 5 is a flowchart illustrating a text output method according to an exemplary embodiment. Referring to FIG. 5, when the user works on a document, the text output apparatus 200 opens the document on the screen and outputs characters input by the user. In operation 510, the text output apparatus 200 determines whether a line breaking command is received from the user. If the line breaking command is not received from the user, the text output apparatus 200 determines whether the number of characters to be output in a horizontal line exceeds the number of characters that can be output in a horizontal line, in operation 520.

When receiving the line breaking command from the user or the number of characters to be output in a horizontal line exceeds the number of characters that can be output in a horizontal line, the text output apparatus 200 determines whether a first command for commanding line breaking in the lower-to-upper direction is received as a line breaking direction command from the user, in operation 530. If the first command is received from the user, the text output apparatus 200 outputs text on a screen by performing line breaking in the lower-to-upper direction, in operation 540.

Otherwise, if the first command is not received from the user, the text output apparatus 200 determines whether a second command for commanding line breaking in the upper-to-lower direction is received as a line breaking direction command from the user, in operation 550. If the second command is received from the user, the text output apparatus 200 outputs the text on the screen by performing line breaking in the upper-to-lower direction, in operation 560.

If the line breaking direction command is not received from the user, the text output apparatus 200 outputs the text on the screen by performing line breaking which is set by default in either the lower-to-upper direction or in the upper-to-lower direction, in operation 570. If the text output apparatus 200 receives the second command from the user while outputting the text with line breaking in the lower-to-upper direction in response to the first command from the user, the text output apparatus 200 may perform line breaking on the previously output text in the upper-to-lower direction and then output the upper-to-lower direction line-broken text. Otherwise, if the text output apparatus 200 receives the first command from the user while outputting the text with line breaking in the upper-to-lower direction in response to the second command from the user, the text output apparatus 200 may perform line breaking on the previously output text in the lower-to-upper direction and then output the lower-to-upper direction line-broken text.

The text output method and apparatus according to the exemplary embodiments may be embodied as a computer-readable code on a computer-readable recording medium. The recording medium may be all kinds of recording devices storing data that is readable by a computer. Examples of the recording medium include read-only memory (ROM), random access memory (RAM), CD-ROMs, magnetic tapes, floppy disks, and optical data storage devices. The computer-readable recording medium can also be distributed over a network of coupled computer systems so that the computer-readable code is stored and executed in a decentralized fashion. A function program, code, and code segments for executing the text output method can be easily construed by programmers of ordinary skill in the art.

While exemplary embodiments have been particularly shown and described, it will be understood by those of ordinary skill in the art that various changes in form and details may be made therein without departing from the spirit and scope of the inventive concept as defined by the following claims. Accordingly, the disclosed embodiment should be considered in an illustrative sense and not in a limiting sense. The scope of the exemplary embodiments are defined by the appended claims, and all differences within the scope will be construed as being included in the inventive concept.

What is claimed is:

1. A text output method comprising outputting characters in horizontal lines on a screen, wherein the outputting the characters comprises outputting the characters by performing line breaking in a lower-to-upper direction.

2. The text output method of claim 1, further comprising receiving a first command which commands line breaking in the lower-to-upper direction,
wherein the outputting the characters by performing line breaking in the lower-to-upper direction comprises outputting the characters on the screen by performing line breaking in the lower-to-upper direction when the line breaking is performed after the receiving the first command.

3. The text output method of claim 2, further comprising receiving a line breaking command, wherein the outputting the characters by performing line breaking in the lower-to-upper direction is executed in response to the line breaking command.

4. The text output method of claim 2, wherein the outputting the characters by performing line breaking in the lower-to-upper direction comprises, if a number of characters to be output in a horizontal line exceeds a number of characters that can be output in a horizontal line on the screen, outputting the exceeding characters on the screen by performing line breaking in an upper direction with respect to a current line.

5. The text output method of claim 2, further comprising, after outputting the characters by performing line breaking in the lower-to-upper direction:
receiving a second command which commands line breaking in an upper-to-lower direction; and
performing line breaking on the lower-to-upper direction line-broken characters output on the screen in the upper-to-lower direction and outputting the upper-to-lower direction line-broken characters when the line breaking is performed after receiving the second command.

6. The text output method of claim 2, further comprising, before outputting the characters by performing line breaking in the lower-to-upper direction:
receiving a second command which commands line breaking in an upper-to-lower direction; and
outputting the characters on the screen by performing line breaking in the upper-to-lower direction,
wherein the outputting the characters by performing line breaking in the lower-to-upper direction comprises performing line breaking on the upper-to-lower direction line-broken characters output on the screen in the lower-to-upper direction and outputting the lower-to-upper direction line-broken characters.

7. A text output method comprising outputting characters in horizontal lines on a screen, wherein the outputting the characters comprises, if a horizontal line including temporally later written characters is different from a horizontal line including temporally earlier written characters, outputting the characters on the screen by positioning the horizontal line including the temporally later written characters in an upper direction with respect to the horizontal line including the temporally earlier written characters.

8. A text output apparatus comprising:
a screen which outputs characters in horizontal lines; and
a text processor which outputs the characters on the screen by performing line breaking in a lower-to-upper direction.

9. The text output apparatus of claim 8, further comprising a user interface receiving a first command which commands line breaking in the lower-to-upper direction,
wherein the text processor outputs the characters on the screen by performing line breaking in the lower-to-upper direction when performing the line breaking after receiving the first command.

10. The text output apparatus of claim 9, wherein the user interface receives a line breaking command, and the text processor outputs the characters by performing line breaking in the lower-to-upper direction in response to the line breaking command.

11. The text output apparatus of claim 9, wherein if a number of characters to be output in a horizontal line exceeds a number of characters that can be output in a horizontal line on the screen, the text processor outputs the exceeding characters on the screen by performing line breaking in an upper direction with respect to a current line.

12. The text output apparatus of claim 9, wherein after the text processor outputs the characters on the screen by performing line breaking in the lower-to-upper direction,
the user interface receives a second command which commands line breaking in an upper-to-lower direction, and
the text processor performs line breaking on the lower-to-upper direction line-broken characters output on the screen in the upper-to-lower direction and outputs the upper-to-lower direction line-broken characters, when performing the line breaking after receiving the second command.

13. The text output apparatus of claim 9, wherein before the text processor outputs the characters by performing line breaking in the lower-to-upper direction,
the user interface receives a second command which commands line breaking in an upper-to-lower direction, and the text processor outputs the characters on the screen by performing line breaking in the upper-to-lower direction in response to the second command, and
the text processor performs line breaking on the upper-to-lower direction line-broken characters output on the screen in the lower-to-upper direction and outputs the lower-to-upper direction line-broken characters.

14. A text output apparatus comprising:
a screen which outputs characters in horizontal lines; and
a text processor, if a horizontal line including temporally later written characters is different from a horizontal line including temporally earlier written characters, which outputs the characters on the screen by positioning the horizontal line including the temporally later written characters in an upper direction with respect to the horizontal line including the temporally earlier written characters.

15. A computer-readable recording medium having recorded thereon a program for executing a text output method comprising:
outputting characters in horizontal lines on a screen, wherein the outputting the characters comprises outputting the characters by performing line breaking in a lower-to-upper direction.

16. A computer-readable recording medium having recorded thereon a program for executing a text output method comprising:
outputting characters in horizontal lines on a screen, wherein the outputting the characters comprises, if a horizontal line including temporally later written characters is different from a horizontal line including temporally earlier written characters, outputting the characters on the screen by positioning the horizontal line including the temporally later written characters in an upper direction with respect to the horizontal line including the temporally earlier written characters.

17. A text output method for performing line breaking when displaying text on a screen, the method comprising:
outputting characters on a screen, and
alternatively displaying the characters in one of a lower-to-upper direction if a first command is received and in an upper-to-lower direction if a second command is received.

18. The method according to claim 17, wherein the characters are displayed in horizontal lines on the screen.

19. The method according to claim 17, wherein when the characters output on the screen are displayed in a lower-to-upper direction, if the second command is received, displaying the currently output characters on the screen in the upper-to-lower direction.

20. The method according to claim 17, wherein when the characters output on the screen are displayed in an upper-to-lower direction, if the first command is received, displaying the currently output characters on the screen in the lower-to-upper direction.
